(19) United States
(12) Patent Application Publication
(10) Pub. No.: US 2021/0195066 A1
(43) Pub. Date: Jun. 24, 2021

(54) IMAGE FORMING APPARATUS AND NON-TRANSITORY COMPUTER READABLE MEDIUM

(71) Applicant: FUJI XEROX CO., LTD., Tokyo (JP)

(72) Inventors: Yusuke KAJI, Kanagawa (JP); Yuma MOTEGI, Kanagawa (JP); Daisuke ISHIHARA, Kanagawa (JP)

(73) Assignee: FUJI XEROX CO., LTD., Tokyo (JP)

(21) Appl. No.: 16/840,640

(22) Filed: Apr. 6, 2020

(30) Foreign Application Priority Data
Dec. 18, 2019 (JP) 2019-228663

(51) Int. Cl. H04N 1/60

(52) U.S. Cl. CPC H04N 1/6027; H04N 1/6055; H04N 1/6036; H04N 1/6041

(57) ABSTRACT

An image forming apparatus includes an image forming device configured to form an image on a sheet using a rotating body under a predetermined image forming condition, a corrector configured to determine a correction amount for the image forming condition to adjust image density unevenness corresponding to a rotation cycle of the rotating body, and a controller configured to control the image forming device to form, on a single sheet, plural test images that are different in the correction amount.

### CROSS-REFERENCE TO RELATED APPLICATIONS

This application is based on and claims priority under 35 USC 119 from Japanese Patent Application No. 2019-228663 filed Dec. 18, 2019.

### BACKGROUND

### 1. Technical Field

The present disclosure relates to an image forming apparatus and a non-transitory computer readable medium.

### 2. Related Art

As a related art, JP-A-2009-288389 discloses an image forming apparatus including an image forming device that forms correction images of different colors on different sheets and outputs a correction chart, and a density unevenness corrector that sets density correction instruction information based on the correction chart and corrects density unevenness.

### SUMMARY

An image forming condition may be corrected in order to reduce image density unevenness corresponding to the rotation cycle of a rotating body such as a developing roller. For example, plural test images that are different in correction amount for an image forming condition are formed on sheets, and an appropriate correction amount is determined based on the test images. Here, when the plural test images which are different in correction amount are formed on the sheets different each other, it may be difficult to determine whether the correction is insufficient and whether the correction is excessive.

Aspects of non-limiting embodiments of the present disclosure relate to making it possible to easily determine whether a correction amount is excessive and whether the correction amount is insufficient, as compared with a case in which test images that are different in correction amount are formed on different sheets.

Aspects of certain non-limiting embodiments of the present disclosure address the above advantages and/or other advantages not described above. However; aspects of the non-limiting embodiments are not required to address the advantages described above, and aspects of the non-limiting embodiments of the present disclosure may not address advantages described above.

According to an aspect of the present disclosure, there is provided an image forming apparatus including an image forming device configured to form an image on a sheet using a rotating body under a predetermined image forming condition, a corrector configured to determine a correction amount for the image forming condition to adjust image density unevenness corresponding to a rotation cycle of the rotating body, and a controller configured to control the image forming device to form, on a single sheet, plural test images that are different in the correction amount.

### BRIEF DESCRIPTION OF THE DRAWINGS

Exemplary embodiment(s) of the present disclosure will be described in detail based on the following figures, wherein:

FIG. 1 is a schematic configuration diagram illustrating an image forming apparatus according to an exemplary embodiment;

FIG. 2 is a schematic view illustrating a relationship between a magnitude of a correction amount for an image forming condition and density unevenness corresponding to the rotation cycle of a rotating body that appears in a test image;

FIG. 3 is a block diagram illustrating a functional configuration of a control device according to the present exemplary embodiment;

FIG. 4 is a diagram illustrating an example of test images formed on a sheet under control of the control device according to the present exemplary embodiment;

FIG. 5 is a diagram illustrating another example of the test images formed on the sheet under the control of the control device according to the present exemplary embodiment;

FIG. 6 is a flowchart illustrating an example of a procedure for checking an appropriate correction amount for an image forming condition based on the test images; and

FIGS. 7A and 7B are diagrams illustrating other forms of pointing portions.

### DETAILED DESCRIPTION

Exemplary embodiments of the present disclosure will be described below with reference to the accompanying drawings.

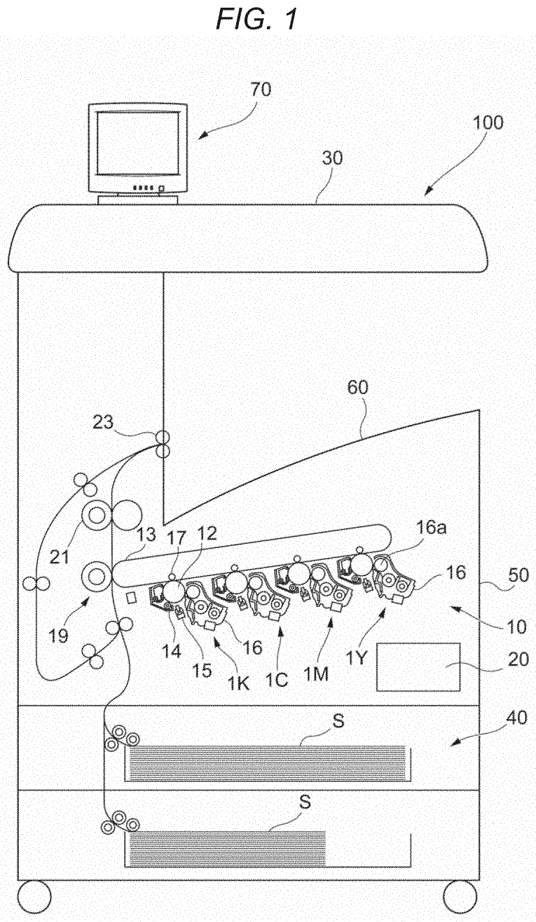

FIG. 1 is a schematic configuration diagram illustrating an image forming apparatus 100 according to an exemplary embodiment. The image forming apparatus 100 illustrated in FIG. 1 is a so-called tandem color printer. The image forming apparatus 100 includes an image forming device 10, a control device 20, an image reader 30, and a sheet feeder 40. The image forming device 10 forms an image based on image data of colors. The control device 20 controls operation of the overall image forming apparatus 100. The image reader 30 reads an image of a document. The sheet feeder 40 feeds sheets S to the image forming device 10.

Here, components of the image forming apparatus 100 are accommodated in a casing 50. A stacking unit 60 is provided below the image reader 30 and on the upper surface of the casing 50. The sheet S on which the image is formed by the image forming device 10 is stacked on the stacking unit 60. An operation unit 70 is provided above the image reader 30. The operation unit 70 receives a user's operation with respect to the image forming apparatus 100.

The image forming device 10 includes four image forming units 1Y, 1M, 1C, and 1K arranged in parallel at regular intervals. The image forming units 1Y, 1M, 1C, and 1K form toner images by a so-called electrophotographic process. Here, the image forming units 1Y, 1M, 1C, and 1K are similarly configured to each other, except for toners accommodated in developing devices 16 which will be described later. The image forming units 1Y, 1M, 1C, and 1K form toner images of yellow (Y), magenta (M), cyan (C), and black (K), respectively. Therefore, in the following description, when the configurations of the image forming units 1Y, 1M, 1C, and 1K do not need to be distinguished from each other, reference signs of “Y”, “M”, “C”, and “K” will be omitted.

The image forming device 10 includes an intermediate transfer belt 13 to which toner images of the respective colors formed on photoconductor drums 12 of the image forming units 1 are transferred. The image forming device 10 includes primary transfer rollers 17 that sequentially transfer (primarily transfer) the toner images of the respective colors formed by the image forming units 1 to the intermediate transfer belt 13. The image forming device 10 includes a secondary transfer roller 19, a fixing device 21, and discharge rollers 23. The secondary transfer roller 19 collectively transfers (secondarily transfers) the toner images of the colors, which are formed on the intermediate transfer belt 13 in a superimposed manner, to a sheet S. The fixing device 21 fixes the secondarily transferred toner images of the colors onto the sheet S. The discharge rollers 23 discharge the sheet S.

Each image forming unit 1 includes the photoconductor drum 12, a charging device 14, an exposure device 15, and a developing device 16. The photoconductor drum 12 carries a toner image. The charging device 14 charges the photoconductor drum 12. The exposure device 15 forms an electrostatic latent image by exposure of the surface of the charged photoconductor drum 12. The developing device 16 develops the electrostatic latent image formed on the photoconductor drum 12 to form the toner image.

The developing device 16 includes a rotatable developing roller 16a that faces the photoconductor drum 12. Each developing device 16 accommodates a developer containing a toner of a corresponding color (for example, yellow toner in the yellow image forming unit 1Y) therein. Magnets are built in the developing roller 16a. The developing roller 16a carries the developer containing the toner on the surface thereof by a magnetic force. In the developing device 16, a predetermined developing bias is applied to the developing roller 16a by a developing power source (not illustrated), so that the toner is transferred from the surface of the developing roller 16a to an image portion of the electrostatic latent image formed on the photoconductor drum 12.

The image forming apparatus 100 executes a series of image forming processing under control of the control device 20. That is, an image processor (not illustrated) performs image processing on image data acquired from a PC (not illustrated) or the image reader 30 to obtain image data of the colors, and sends the image data of each color to the exposure device 15 of the corresponding image forming unit 1. Then, the exposure device 15 performs the exposure and the developing device 16 performs the development, so that the toner image is formed on the photoconductor drum 12.

The toner images of the respective colors formed on the photoconductor drums 12 of the respective image forming units 1 are primarily transferred onto the intermediate transfer belt 13 by the respective primary transfer rollers 17 in sequence. As a result, a superimposed toner image in which the toners of the colors are superimposed is formed on the intermediate transfer belt 13. The superimposed toner image is transported toward the secondary transfer roller 19 with traveling of the intermediate transfer belt 13.

The sheet S fed from the sheet feeder 40 is transported to the secondary transfer roller 19 in accordance with a transportation timing of the superimposed toner image on the intermediate transfer belt 13. Then, the superimposed toner image on the intermediate transfer belt 13 is secondarily transferred onto the sheet S by the secondary transfer roller 19. The superimposed toner image transferred to the sheet S is fixed onto the sheet S by the fixing device 21, and then discharged to the stacking unit 60 by the discharge rollers 23.

In the image forming apparatus 100, each image forming unit 1 includes a rotating body such as the developing roller 16a of the developing device 16 and the photoconductor drum 12. In the image formed on the sheet S by the image forming apparatus 100, density unevenness corresponding to the rotation cycle of the rotating body may occur due to eccentricity of the rotating body or unevenness of the outer peripheral surface of the rotating body. Here, the “density unevenness corresponding to the rotation cycle of the rotating body” is a variation in image density that occurs in a sub-scanning direction of the sheet S when an image is formed on the sheet S at a uniform image density.

The image forming apparatus 100 corrects an image forming condition in order to reduce such density unevenness corresponding to the rotation cycle of the rotating body. As will be described later in detail, the image forming apparatus 100 performs predetermined correction on the image forming condition, forms test images on the sheet S, and determines an appropriate correction amount based on the test images. More specifically, the image forming apparatus 100 forms, on the sheet S, plural test images that are different in correction amount for the image forming condition. Then, a user visually checks the plural test images, which are different in correction amount and are formed on the sheet S, to determine an appropriate correction amount.

The test images are not particularly limited to specific ones, but may be any test images that make it possible to check the density unevenness corresponding to the rotation cycle of the rotating body. Examples of the test images include rectangular or strip-shaped images each having a length, in the sub-scanning direction, equal to or longer than a length corresponding to the rotation cycle of the rotating body.

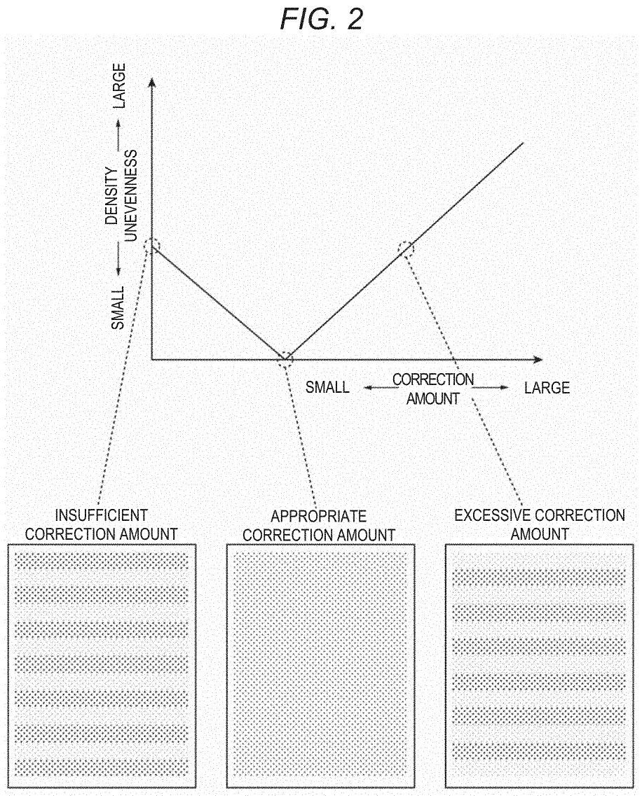

FIG. 2 is a schematic diagram illustrating a relationship between the magnitude of the correction amount for the image forming condition and the density unevenness corresponding to the rotation cycle of the rotating body that appears in the test image.

As illustrated in FIG. 2, in the test image, a high density portion (a portion having a dark color) and a low density portion (a portion having a pale color) alternately appear in the sub-scanning direction in accordance with the rotation cycle of the rotating body. A density difference between the high density portion and the low density portion corresponds to the density unevenness corresponding to the rotation cycle of the rotating body that appears in an image. The smaller the density difference between the high density portion and the lower density portion is, the more appropriate the correction amount for the image forming condition is. In the following description, a correction amount for an image forming condition that generate no density difference in a test image may be referred to as an “appropriate correction amount”.

Here, as illustrated in FIG. 2, phases of a high density portion and a low density portion that appear in accordance with the rotation cycle of the rotating body in a case where a correction amount for an image forming condition is smaller than an appropriate correction amount (that is, in a case where the correction amount is insufficient for the appropriate correction amount) are opposite to those in a case where the correction amount for the image forming condition is larger than the appropriate correction amount (that is, in a case where the correction amount is excessive for the appropriate correction amount). However, when a user looks at a test image that is insufficient in correction amount and a test image that is excessive in correction amount individually, it is difficult for him or her to check the phases of a high density portion and a low density portion so as to determine (i) whether the correction amount is insufficient for the appropriate correction amount and (ii) whether the correction amount is excessive for the appropriate correction amount.

In contrast, in the present exemplary embodiment, plural test images that are different in correction amount for an image forming condition are formed on a single sheet S. This enables the user to easily determine, based on the plural test images formed on the sheet S, whether the phases of the high density portion and the low density portion that appear in accordance with the rotation cycle of the rotating body are equal to each other or opposite to each other. Then, this also enables the user to easily determine whether the correction amount is insufficient for the appropriate correction amount or whether the correction amount is excessive for the appropriate correction amount.

In the following description, phases of a high density portion and a low density portion that appear in a test image in accordance with the rotation cycle of a rotating body may be referred to as a “phase of density unevenness”.

Next, description will be given on the configuration of the control device 20 and test images formed on a sheet S under control of the control device 20. Hereinafter, a case where two test images that are different in correction amount for an image forming condition are formed on the sheet S as plural test images will be described as an example. More specifically, a case where a first test image T1 in which the correction amount for the image forming condition is a first correction amount a1 and a second test image T2 in which the correction amount for the image forming condition is a second correction amount a2 are formed on a single sheet S will be described as an example.

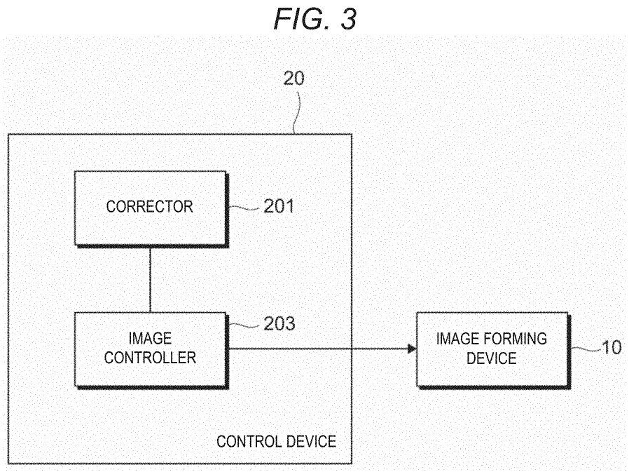

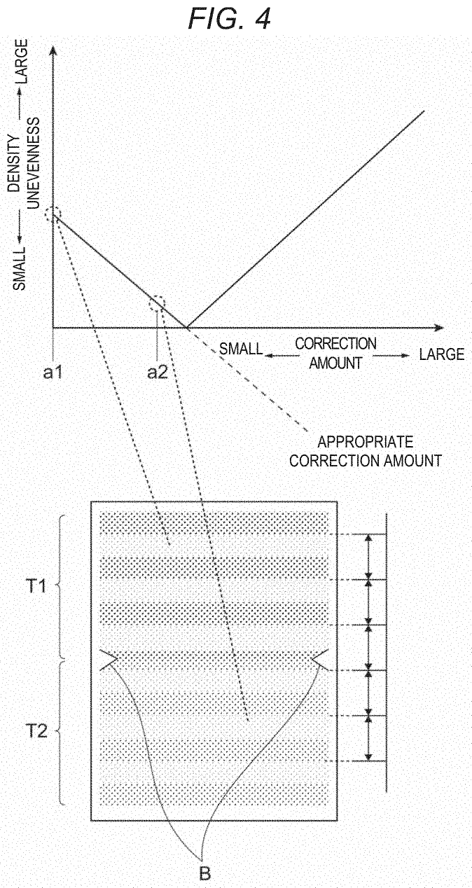

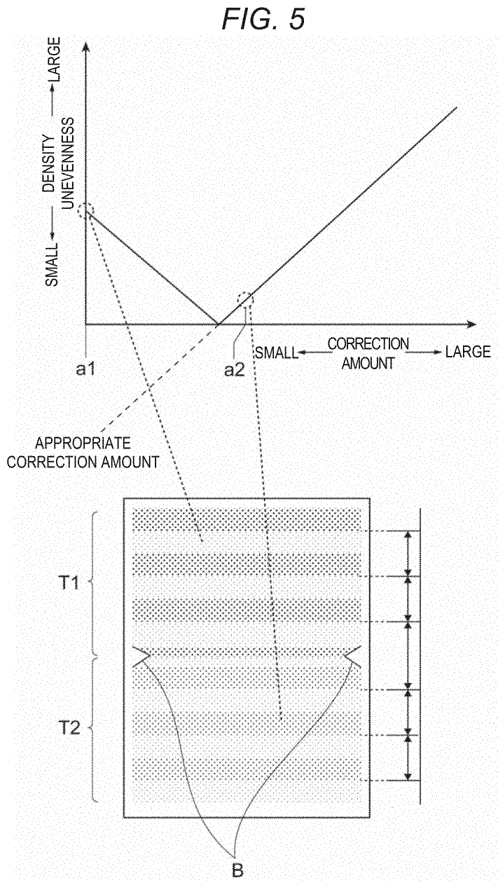

FIG. 3 is a block diagram illustrating a functional configuration of the control device 20 according to the present exemplary embodiment. Further, FIGS. 4 and 5 are diagrams illustrating examples of test images formed on the sheet S under the control of the control device 20 according to the present exemplary embodiment. FIG. 4 illustrates a case where both the first correction amount a1 of the first test image T1 and the second correction amount a2 of the second test image T2 are smaller than the appropriate correction amount. FIG. 5 illustrates a case where the first correction amount a1 of the first test image T1 is smaller than the appropriate correction amount, while the second correction amount a2 of the second test image T2 is larger than the appropriate correction amount.

The control device 20 includes a central processing unit (CPU), a read only memory (ROM), and a random access memory (RAM). The ROM stores a control program to be executed by the CPU. The CPU reads out the control program stored in the ROM, and executes the control program using the RAM as a work area. The CPU executes the control program to control the elements of the image forming apparatus 100.

As illustrated in FIG. 3, the control device 20 includes a corrector 201 and an image controller 203. The corrector 201 determines correction amounts for an image forming condition under which the image forming device 10 forms an image on a sheet S. The image controller 203 is an example of a controller. The image controller 203 controls the image forming device 10 to form plural test images that are different in correction amount on a single sheet S using the correction amounts for the image forming condition determined by the corrector 201. The corrector 201 is not limited to one implemented by the CPU executing the control program. The corrector 201 may be implemented, for example, by an electronic circuit.

The corrector 201 determines the correction amount for the image forming condition to adjust density unevenness corresponding to the rotation cycle of the rotating body. Examples of the image forming condition for which the corrector 201 determines the correction amount include an exposure amount by the exposure device 15, the magnitude of a developing bias applied to the developing roller 16a of the developing device 16, and the magnitude of a charging bias of the charging device 14. The image forming condition for which the corrector 201 determines the correction amount is not particularly limited to the above examples, but may be any image forming condition that can adjust image density unevenness corresponding to the rotation cycle of a rotating body.

The corrector 201 determines plural correction amounts to be applied to respective test images when the plural test images are formed on a single sheet S. In this example, the corrector 201 determines the first correction amount a1 and the second correction amount a2 as plural correction amounts. The second correction amount a2 is larger than the first correction amount a1 (that is, the first correction amount a1<the second correction amount a2).

Here, it may be clear whether at least one correction amount among the plural correction amounts determined by the corrector 201 is smaller than the appropriate correction amount or larger than the appropriate correction amount. In this example, it is assumed that the corrector 201 sets the first correction amount a1 to 0 (that is, no correction) such that it is clear that the first correction amount a1 is smaller than the appropriate correction amount.

The image controller 203 controls the image forming device 10 to form plural test images on a single sheet S with toner of predetermined colors under image forming conditions to which the plural correction amounts determined by the corrector 201 are applied, respectively. More specifically, the image controller 203 controls the elements of the image forming device 10 using the correction amounts determined by the corrector 201, so as to cancel the density unevenness corresponding to the rotation cycle of the rotating body.

In this example, the image controller 203 applies the first correction amount a1 to the image forming condition to form the first test image T1 on the sheet S, and applies the second correction amount a2 to the same sheet S to form the second test image T2.

The image controller 203 forms the plural test images on the single sheet S side by side in the sub-scanning direction in which the density unevenness corresponding to the rotation cycle of the rotating body occurs. In this example, as illustrated in FIGS. 4 and 5, the first test image T1 and the second test image T2 are formed side by side in the sub-scanning direction. For example, the image controller 203 controls the image forming device 10 to change the correction amount to be applied to the image forming condition from the first correction amount a1 to the second correction amount a2 during formation of the test images on the single sheet S. In this case, the first test image T1 and the second test image T2 are continuously formed in the sub-scanning direction on the sheet S.

In the present exemplary embodiment, the plural test images are formed side by side on the single sheet S, so that the user can easily compare the plural test images with each other. When the plural test images are formed side by side on the single sheet S, the plural test images may be formed continuously or intermittently.

The image controller 203 may form the first test image T1 and the second test image T2 so as to each include an image corresponding to at least one rotation cycle of the rotating body. That is, as illustrated in FIGS. 4 and 5, the image controller 203 may form the first test image T1 and the second test image T2 such that each of the first test image T1 and the second test image T2 includes at least one high density portion that is generated in accordance with the rotation cycle of the rotating body and at least one low density portion that is generated in accordance with the rotation cycle of the rotating body.

In addition to the plural test images, the image controller 203 forms pointing portions B indicating the boundary between the plural test images, on the sheet S. In this example, the image controller 203 forms, on the sheet S, the pointing portions B indicating the boundary between the first test image T1 and the second test image T2, which are formed side by side in the sub-scanning direction.

The pointing portion B is not particularly limited to specific one, but may be any pointing portion that enables a user who visually recognizes the sheet S to know the position of the boundary between the first test image T1 and the second test image T2. In this example, as illustrated in FIGS. 4 and 5, triangular notches are formed at the boundary between the first test image T1 and the second test image T2 so as to remove portions at both ends in the main scanning direction. The vertexes of the notches indicate the position of the boundary between the first test image T1 and the second test image T2.

Here, as illustrated in FIG. 4, when the phases of the density unevenness of the first test image T1 and the second test image T2 are equal to each other, intervals (pitch) at which the high density portion (or the low density portion) appear are equal across the boundary between the first test image T1 and the second test image T2. On the other hand, as illustrated in FIG. 5, when the phases of the density unevenness of the first test image T1 and the second test image T2 are different from each other, the intervals (pitch) at which the high density portion (or the low density portion) appears change at the boundary between the first test image T1 and the second test image T2.

In the present exemplary embodiment, the pointing portions B formed on the sheet S enables the user who visually recognizes the sheet S to easily know the position of the boundary between the first test image T1 and the second test image T2. Thus, it is easy for the user to understand whether an interval between high density portions (or an interval between low density portions) changes at the boundary between the first test image T1 and the second test image T2. As a result, it is easy for the user to determine whether the first test image T1 and the second test image T2 are different in phase of the density unevenness appearing in accordance with the rotation cycle of the rotating body.

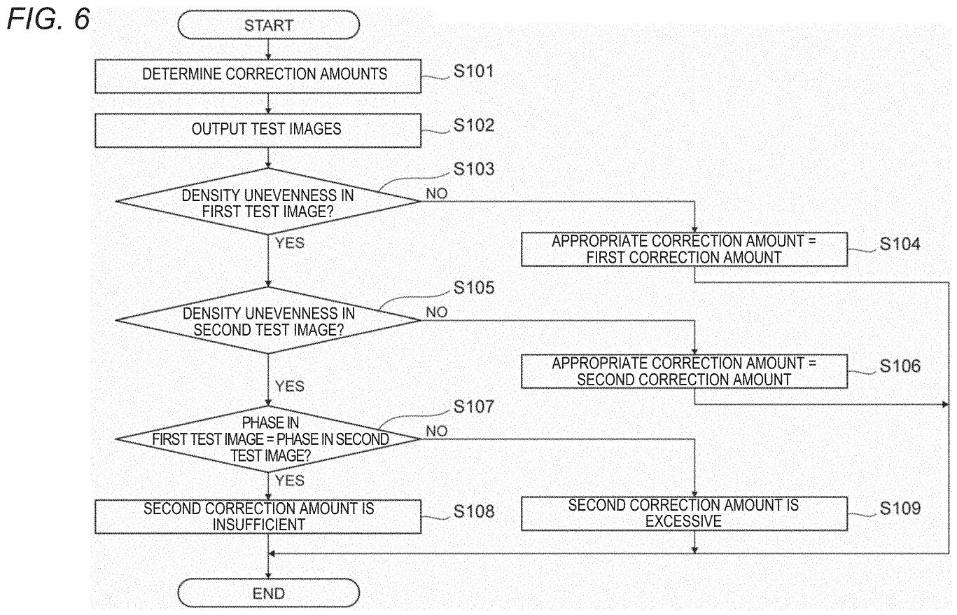

Next, an example of a procedure for forming test images on a sheet S in the image forming apparatus 100 of the present exemplary embodiment and checking an appropriate correction amount for an image forming condition based on the test images will be described. FIG. 6 is a flowchart illustrating the example of the procedure for checking the appropriate correction amount for the image forming condition based on the test images.

When checking the appropriate correction amount for the image forming condition, the user instructs the image forming apparatus 100, for example, via the operation unit 70 to output test images. When the user instructs the image forming apparatus 100 to output the test images, the corrector 201 of the control device 20 determines correction amounts for the image forming condition to be applied to the test images (step 101). In this example, the corrector 201 determines the first correction amount a1 (=0) to be applied to the first test image T1 and the second correction amount a2 (>a1) to be applied to the second test image T2.

Next, the image forming apparatus 100 forms plural test images that are different in correction amount on a single sheet S and outputs the test images under control of the image controller 203 (step 102). In this example, the image forming apparatus 100 forms the first test image T1 to which the first correction amount a1 (=0) is applied and the second test image T2 to which the second correction amount a2 (>first correction amount a1) is applied, and outputs the first and second test images T1, T2.

Next, the user visually checks the first test image T1 formed on the sheet S, and determines whether density unevenness occurs in the first test image T1 (step 103).

When the user determines that no density unevenness occurs in the first test image T1 (NO in step 103), the user inputs to the image forming apparatus 100 via the operation unit 70 that no density unevenness occurs in the first test image T1. Then, the corrector 201 of the control device 20 determines that the first correction amount a1 is the appropriate correction amount (step 104).

On the other hand, when the user determines that the density unevenness occurs in the first test image T1 (YES in step 103), the user visually checks the second test image T2 formed on the sheet S, and determines whether density unevenness occurs in the second test image T2 (step 105).

When the user determines that no density unevenness occurs in the second test image T2 (NO in step 105), the user inputs to the image forming apparatus 100 via the operation unit 70 that no density unevenness occurs in the second test image T2. Then, the corrector 201 of the control device 20 determines that the second correction amount a2 is the appropriate correction amount (step 106).

On the other hand, when the user determines that the density unevenness occurs in the second test image T2 (YES in step 105), the user visually checks the relationship between the phase of the density unevenness of the first test image T1 and the phase of the density unevenness of the second test image T2. That is, the user determines whether the phase of the density unevenness of the first test image T1 is equal to that of the second test image T2 (step 107).

When the user determines that the phase of the density unevenness of the first test image T1 is equal to that of the second test image T2 (YES in step 107), the user inputs to the image forming apparatus 100 via the operation unit 70 that the phase of the density unevenness of the first test image T1 is equal to that of the second test image T2.

As described above, when the phase of the density unevenness of the first test image T1 is equal to that of the second test image T2, both the first correction amount a1 and the second correction amount a2 are smaller than the appropriate correction amount. Therefore, the corrector 201 of the control device 20 determines that the second correction amount a2 is insufficient (step 108), and ends the series of processes. In this case, the corrector 201 may newly set a first correction amount a1′ and a second correction amount a2′ that are larger than the second correction amount a2, and return to the step 102 to continue the processing using the first correction amount a1′ and the second correction amount a2′.

On the other hand, when the user determines that the phase of the density unevenness of the first test image T1 is different from that of the second test image T2 (NO in step 107), the user inputs to the image forming apparatus 100 via the operation unit 70 that the phase of the density unevenness of the first test image T1 is different from that of the second test image T2.

As described above, when the phase of the density unevenness of the first test image T1 is different from that of the second test image T2, the first correction amount a1 is smaller than the appropriate correction amount, and the second correction amount a2 is larger than the appropriate correction amount. Therefore, the corrector 201 of the control device 20 determines that the second correction amount a2 is excessive (step 109), and ends the series of processes. In this case, the corrector 201 may newly set a second correction amount a2″ smaller than the second correction amount a2, and return to step 102 to continue the processing using the first correction amount a1 and the second correction amount a2″.

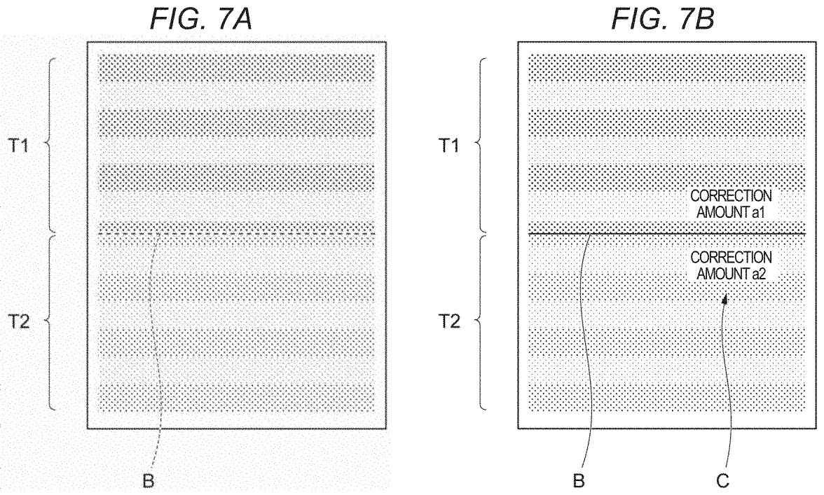

Next, another form of the pointing portion B formed on the sheet S will be described. FIGS. 7A and 7B are diagrams illustrating other forms of the pointing portion B. FIGS. 7A and 7B illustrate examples of the first test image T1, the second test image T2, and the pointing portions B formed on a single sheet S.

As described above, the form of the pointing portion B is not particularly limited to the above described exemplary embodiment, but may be any pointing portion that indicates the position of the boundary between plural test images formed on a single sheet S.

The pointing portions B illustrated in FIGS. 4 and 5 are provided at both ends in the main scanning direction. Alternatively, the pointing portion B may have a linear shape extending continuously in the main scanning direction at the boundary between the first test image T1 and the second test image T2 as illustrated in FIG. 7A. Since the pointing portion B is continuous in the main scanning direction, the user can easily know the position of the boundary between the first test image T1 and the second test image T2, even in a center area in the main scanning direction of the sheet S, for example.

As illustrated in FIG. 7B, in addition to the pointing portion B, information C on a correction amount for an image forming condition applied to each test image may be indicated on the sheet S. In this example, (i) information on the first correction amount a1 applied to the first test image T1 and (ii) information on the second correction amount a2 applied to the second test image T2 are indicated on the sheet S.

As described above, the image forming apparatus 100 of the present exemplary embodiment forms, on a single sheet S, plural test images that are different in correction amount for an image forming condition. This enables a user to easily determine, based on the plural test images formed on the sheet S, whether the correction amount is insufficient for an appropriate correction amount or whether the correction amount is excessive for the appropriate correction amount.

The present disclosure is not limited to the above-described exemplary embodiment. For example, the present disclosure may be applied to an intermediate transfer body of an inkjet printer. Various modifications and combinations may be made to the exemplary embodiment described above without departing from the spirit of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image forming apparatus comprising:
an image forming device configured to form an image on a sheet using a rotating body under a predetermined image forming condition;
a corrector configured to determine a correction amount for the image forming condition to adjust image density unevenness corresponding to a rotation cycle of the rotating body: and
a controller configured to control the image forming device to form, on a single sheet, a plurality of test images that are different in the correction amount.

2. The image forming apparatus according to claim 1, wherein the controller forms the plurality of test images, which are different in the correction amount, side by side on the single sheet.

3. The image forming apparatus according to claim 2, wherein the controller further forms, on the sheet, a pointing portion indicating a position of a boundary between the plurality of test images.

4. The image forming apparatus according to claim 2, wherein the controller forms the plurality of test images side by side in a direction in which the image density unevenness corresponding to the rotation cycle of the rotating body may occur.

5. The image forming apparatus according to claim 4, wherein the controller causes the image forming unit to form the test images such that each test image includes the image density unevenness corresponding to at least one rotation cycle of the rotating body.

6. The image forming apparatus according to claim 1, wherein the controller forms information on the correction amount of each test image on the sheet.

7. The image forming apparatus according to claim 1, wherein the corrector determines at least one of the plurality of correction amounts, which are to be applied to the plurality of test images, to be a correction amount that is clearly excessive or insufficient for an appropriate correction amount that generates no image density unevenness.

8. The image forming apparatus according to claim 7, wherein the corrector determines the at least one of the plurality of correction amounts to be applied to the plurality of test images to be 0.

9. A non-transitory computer readable medium storing a program that causes a computer to execute image formation processing, the image forming processing comprising:
determining a correction amount for an image forming condition to adjust image density unevenness corresponding to a rotation cycle of a rotating body, an image forming device being configured to form an image using the rotating body under the image forming condition; and
controlling the image forming device to form a plurality of test images that are different in correction amount on a single sheet.

10. An image forming apparatus comprising:
image forming means for forming an image on a sheet using a rotating body under a predetermined image forming condition;
correction means for determining a correction amount for the image forming condition to adjust image density unevenness corresponding to a rotation cycle of the rotating body; and
control means for controlling the image forming means to form, on a single sheet, a plurality of test images that are different in the correction amount.
